(19) United States
(12) Patent Application Publication
(10) Pub. No.: US 2002/0133420 A1
(43) Pub. Date: Sep. 19, 2002

(54) System and method for installing a software product on a network server device

(76) Inventors: Craig McCoy, Boise, ID (US); John M. Hall, Boise, ID (US)

Correspondence Address: HEWLETT-PACKARD COMPANY, Intellectual Property Administration, P.O. Box 272400, Fort Collins, CO, 80527-2400, US

(21) Appl. No.: 09/810,174

(22) Filed: Mar. 15, 2001

(51) Int. Cl. G06F 17/60

(52) U.S. Cl. 705/26

(57) ABSTRACT

A system and method of installing components of a software product on a first network server device coupled to a network includes automatically detecting with the first network server device a first set of server-assisted network devices coupled to the network that are eligible to use a first service. The components of the software product provide the first network server device the capability to provide the first service to a plurality of server-assisted network devices coupled to the network. Device information based on the detected server-assisted network devices is automatically transmitted to a second network server device. License information is received from the second network server device based on the transmitted device information. Components of the software product are automatically installed on the first network server device.

### THE FIELD OF THE INVENTION

The present invention generally relates to computer networks, and more particularly to a method for automatically installing and configuring a software product on a network server device to provide a service to one or more server-assisted network devices.

### BACKGROUND OF THE INVENTION

In addition to using a personal computer (PC) for transferring data to a network, another option for transferring information to a network is a “digital sender”. A digital sender is a network device that converts paper-based documents into electronic data. A digital sender includes a scanner for scanning in paper documents. The digital sender can send the electronic data by several methods, including via Internet e-mail and via facsimile (Fax) either through a network fax server or an Internet fax service provider.

One known manufacturer of different models of digital senders is Hewlett-Packard Company. Information regarding Hewlett-Packard digital senders is publicly available via Hewlett-Packard's website at www.hp.com. Information regarding Hewlett-Packard's digital senders is also provided in “HP 9100C Digital Sender User Guide,” 1^{st} ed., 1998, Pub. No. C1311-90910, and “HP 9100C Digital Sender Administrator Guide,” 1^{st} ed., 1998, Pub. No. C1311-90915, which are incorporated herein by reference.

A digital sender allows data to be transferred to the Internet with fewer steps than that required by a PC. The digital sender includes a keypad that allows a user to enter an e-mail address. A user can scan in a document, enter one or more e-mail addresses for the desired destinations, press a send button, and the digital sender automatically e-mails the information to the various destinations. The digital sender automatically logs onto an exchange server, and transmits an e-mail message with the scanned document attached, without any further user input required. Thus, a digital sender provides a more efficient means for transferring paper-based source information to the Internet.

In one embodiment, a digital sender is a server-assisted network device. A server-assisted network device is a device that relies on a server on the network to provide some functionality. Thus, the functionality need only be installed on a single server, rather than on multiple network devices. Other examples of server assisted network devices include printers, scanners, and PCs. For example, a digital sender or PC may rely on an email server (e.g., simple mail transport protocol or SMTP server) to send or receive email communications. A digital sender or scanner may also rely on a server to provide digital sender services, such as converting a scanned document to an email or fax communication. The server provides new functionality to a server-assisted network device that did not exist before, or that performs in a different manner than previously performed.

In order to provide a service to a server-assisted network device, components of a software product must be installed and configured on the server and on the server-assisted network device to implement the desired service. Currently, installation and configuration of such software components is a manual process that requires numerous manual steps to be executed by a network administrator. The software may be installed by numerous methods, including installing from a floppy disk or compact disk, or downloading the software from the Internet. Once installed, the software must be configured. Currently, in order to configure a server to provide service to server-assisted network devices, the network administrator must examine the network and identify which server-assisted network devices are present, which devices do not currently have the service, and which devices should have the service. The identified devices are manually entered by the administrator. For example, for printers, the administrator would have to set up a printer in a printers folder on the server for each identified printer on the network that is to be provided a service by the server. The administrator selects the features that each device is to have, and manually configures each identified device and the server. The administrator must then provide information regarding the number of devices that will use the service and the features to be implemented by these devices to a licensing source. The administrator then manually obtains license information for the identified devices from the licensing source, typically by phone, mail, or through the Internet. The administrator next must enter the license information on the devices. For example, if 50 different server-assisted network devices were selected, 50 different licenses would have to be obtained, and 50 different license numbers would have to be entered. The numerous manual steps currently required to install a software product on a server are time consuming, and increase the likelihood of errors occurring due to administrator mistakes.

It would be desirable to automate the process of installing and configuring components of a software product on a server and on server-assisted network devices to provide a desired service.

### SUMMARY OF THE INVENTION

The present invention is directed to the installation of components of a software product on a first network server device coupled to a network by automatically detecting with the first network server device a set of server-assisted network devices coupled to the network that are eligible to use a service. The components of the software product provide the first network server device the capability to provide the service to a plurality of server-assisted network devices coupled to the network. Device information based on the detected server-assisted network devices is automatically transmitted to a second network server device. License information is received from the second network server device based on the transmitted device information. Components of the software product are automatically installed on the first network server device.

### BRIEF DESCRIPTION OF THE DRAWINGS

FIG. 1 illustrates a block diagram of a network, including a server and a plurality of server-assisted network devices.

FIG. 2 illustrates an electrical block diagram of a server-assisted network device.

FIG. 3 illustrates an electrical block diagram of a network server device.

FIG. 4 illustrates a flow diagram of automatic installation and configuration operations performed in one embodiment of the present invention.

FIG. 5 illustrates one embodiment of a screen presented to an administrator during installation of a software product on a server according to the present invention.

### DESCRIPTION OF THE PREFERRED EMBODIMENTS

In the following detailed description of the preferred embodiments, reference is made to the accompanying drawings, which form a part hereof, and in which is shown by way of illustration specific embodiments in which the invention may be practiced. It is to be understood that other embodiments may be utilized and structural or logical changes may be made without departing from the scope of the present invention. The following detailed description, therefore, is not to be taken in a limiting sense, and the scope of the present invention is defined by the appended claims.

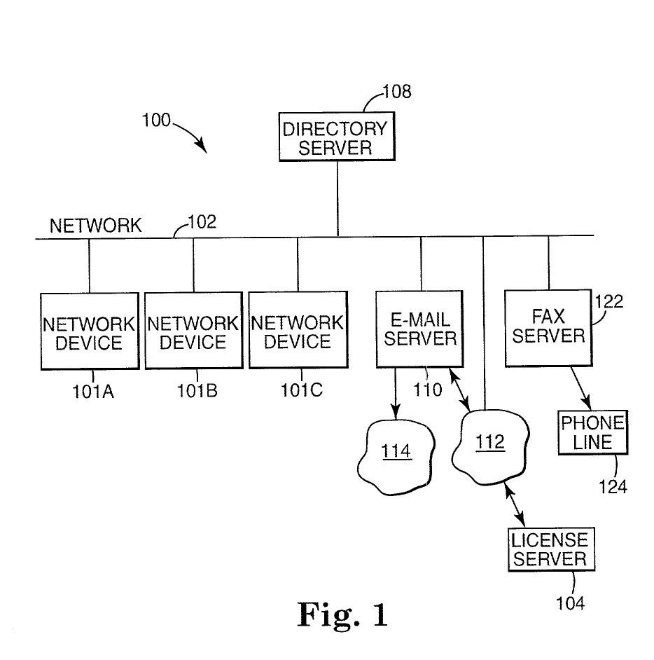

FIG. 1 illustrates a diagram of a network. Network 100 includes server-assisted network devices 101A-101C (collectively referred to as server-assisted network devices 101), communication link 102, license server 104, directory server 108, e-mail server 110, Internet 112, Internet fax service provider 114, fax server 122, and phone line 124. Server-assisted network devices 101 according to the present invention include any network device that relies on a server on a network to provide some functionality. Server-assisted network devices 101 may be printers, scanners, PCs, digital senders, and any other network device that relies on a server to provide some functionality. License server 104 is coupled to Internet 112. In one embodiment, directory server 108 is a light-weight directory access protocol (LDAP) server. E-mail server 110 preferably supports simple mail transport protocol (SMTP). In one embodiment, a permanent TCP/IP network connection exists between server-assisted network device 101A and e-mail server 110.

The present invention will be discussed primarily with reference to a single server-assisted network device 101A. In one embodiment, server-assisted network device 101A is a digital sender. One of ordinary skill in the art will recognize that the techniques described herein are equally applicable to the other server-assisted network devices 101B-101C, regardless of what type of server-assisted network devices these are (e.g., PC, printer, scanner, or other device).

Server-assisted network device 101A allows users to send e-mail communications, with or without attachments, as well as fax communications. In one embodiment, server-assisted network device 101A relies on server computers, including e-mail server 110 and fax server 122, to provide email and fax functionality. Server-assisted network device 101A preferably includes a keyboard or other input means for entering destination information, output format information, sender information, and subject information. In one embodiment, the destination information specifies one or more email addresses and/or one or more fax phone numbers. The destination information entered by a user may specify multiple destinations for each data item to be transmitted. The output format information identifies the format for items to be sent, including e-mail format, fax format and internet fax format. The sender information provides identifying information about the sender, such as a name or e-mail address. The subject information identifies a subject of data items to be transmitted.

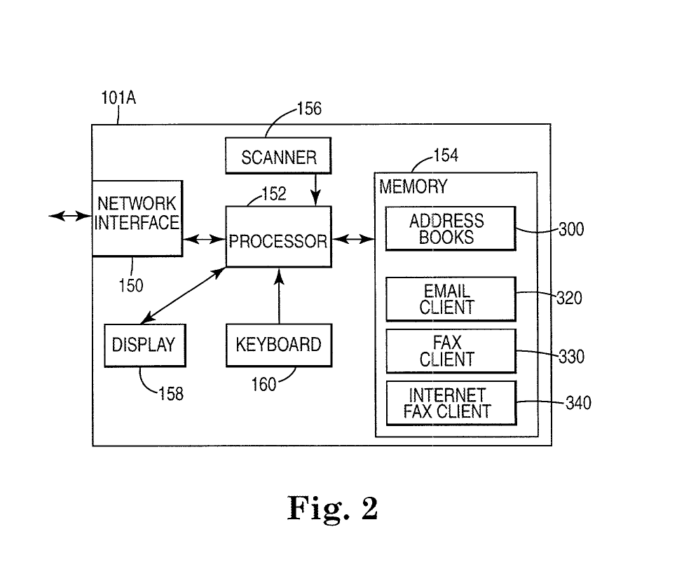

FIG. 2 illustrates an electrical block diagram of a server-assisted network device according to the present invention. Server-assisted network device 101A includes network interface 150, processor 152, memory 154, scanner 156, display 158, and keyboard 160. Server-assisted network device 101A preferably does not require a PC to connect to a network, but rather hooks directly into network 100 via network interface 150. Server-assisted network device 101A runs on any TCP-IP network, including Ethernet (10Base-T, 100Base-T or 10Base-2) or token ring.

Network interface 150 is coupled to communication link 102 of network 100, and to processor 152. Server-assisted network device 101A transmits communications through network interface 150 to network 100. Server-assisted network device 101 also receives communications from network 100 through network interface 150. Network interface 150 passes the received communications on to processor 152.

Data is entered into server-assisted network device 101A by a user via keyboard 160. Data is displayed by server-assisted network device 101A via display 158. Alternative methods of data entry and display may be used, including a touch screen display.

Users provide input data items to server-assisted network device 101A, such as a paper-based document, and processor 152 generates one or more output data items based on the input data items, and on the entered destination information, output format information, sender information, and subject information. Memory 154 stores information provided by a user, one or more internal address books 300, email client software 320, fax client software 330, and internet fax client software 340. Email client software 320, fax client software 330, and internet fax client software 340 provide server-assisted network device 101A with the ability to provide email and fax functionality using services provided email server 110 and fax server 122.

In one embodiment, an output data item generated by processor 152 takes the form of an e-mail message. An e-mail message generated by processor 152 preferably includes two parts. The first part is a header, which contains sender and destination information. The second part is a digitized document attachment. Scanner 156 generates the digitized document by converting a paper-based document into a digital document format, such as PDF or TIFF format. The type of document format is specified in the output format information entered by a user. The PDF (or TIFF) file is attached to an e-mail message by processor 152. Processor 152 preferably uses multi-part Internet message encoding (MIME) to encode e-mail messages. Processor 152 communicates with e-mail server 110 to provide email capabilities using email client software 320. Email addresses may be entered via keyboard 160 on server-assisted network device 101, or they can be retrieved from an internal address book 300 stored in memory 154. In addition, server-assisted network device 101A also supports LDAP queries, which provides the ability of real-time address queries. The LDAP capabilities are provided by directory server 108.

Server-assisted network device 101A includes the capability to send faxes. Fax server 122 includes phone line 124 to fax communications received from server-assisted network device 101A. Fax server 122 handles outbound dialing to fax communications received from server-assisted network device 101A over phone line 124. Processor 152 communicates with fax server 122 to provide fax capabilities using fax client software 330. Fax numbers may be entered via keyboard 160 on server-assisted network device 101A, or they can be retrieved from an internal address book 300 stored in memory 154.

Server-assisted network device 101A is also capable of sending faxes via the Internet. To provide Internet fax capabilities, the user must subscribe to an Internet fax service provider service. E-mail server 110 provides Internet fax capabilities using Internet fax service provider 114. In order to transmit a document via Internet fax, server-assisted network device 101A transmits a communication via communication link 102 to e-mail server 110, which handles the Internet fax transmission. Processor 152 communicates with e-mail server 110 to provide internet fax capabilities using internet fax client software 340. Internet fax destinations are entered in server-assisted network device 101A via keyboard 160, or they can be retrieved from an internal address book 300 stored in memory 154.

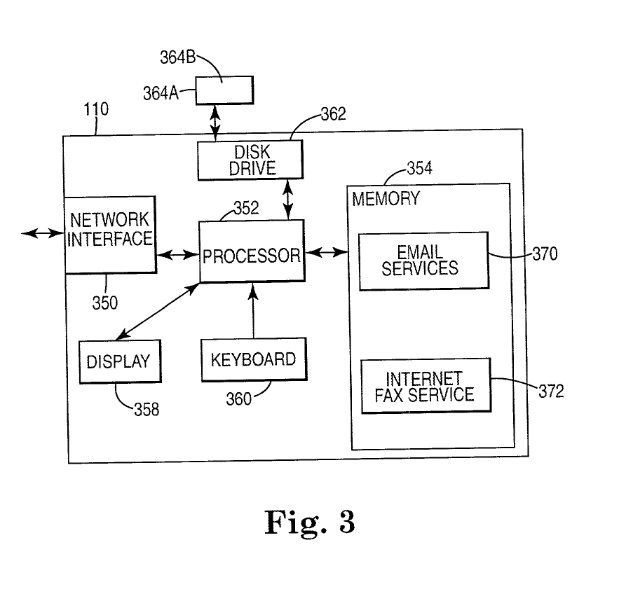

FIG. 3 illustrates a partial electrical block diagram of e-mail server 110. E-mail server 110 includes network interface 350, processor 352, memory 354, display 358, keyboard 360, disk drive 362, and floppy disk 364A. Memory 354 stores e-mail service software 370 and internet fax service software 372. E-mail service software 370 provides e-mail server 110 the capability to provide e-mail service to one or more of server-assisted network devices 101. Similarly, internet fax service software 372 provides e-mail server 110 the capability to provide internet fax service to one or more of server-assisted network devices 101. Fax server 122 has a similar configuration as shown in FIG. 3 for e-mail server 110, but includes a memory that stores fax service software for providing telephone fax service to one or more of server-assisted network devices 101.

The present invention will be discussed in the context of the installation and configuration of e-mail service software 370 and internet fax service software 372 on e-mail server 110, and of email client software 320 and internet fax client software 340 on server-assisted network device 101A, although the techniques described herein are applicable to any software to be installed on a network server and server-assisted network device for providing service to one or more server-assisted network devices.

In one embodiment, service software 370 and 372 are provided in a bundled package as software product 364B stored on floppy disk 364A. One of ordinary skill in the art will recognize that e-mail service software 370 and internet fax service software 372 may be provided as separate software packages, and may be stored in any conventional manner including floppy disk, compact disk, or other storage medium, or may be downloaded from the Internet 112.

Installation of software product 364B begins by inserting floppy disk 364A in disk drive 362 of e-mail server 110. After insertion, the installation may be started automatically, or may require the administrator to run a particular file on floppy disk 364A.

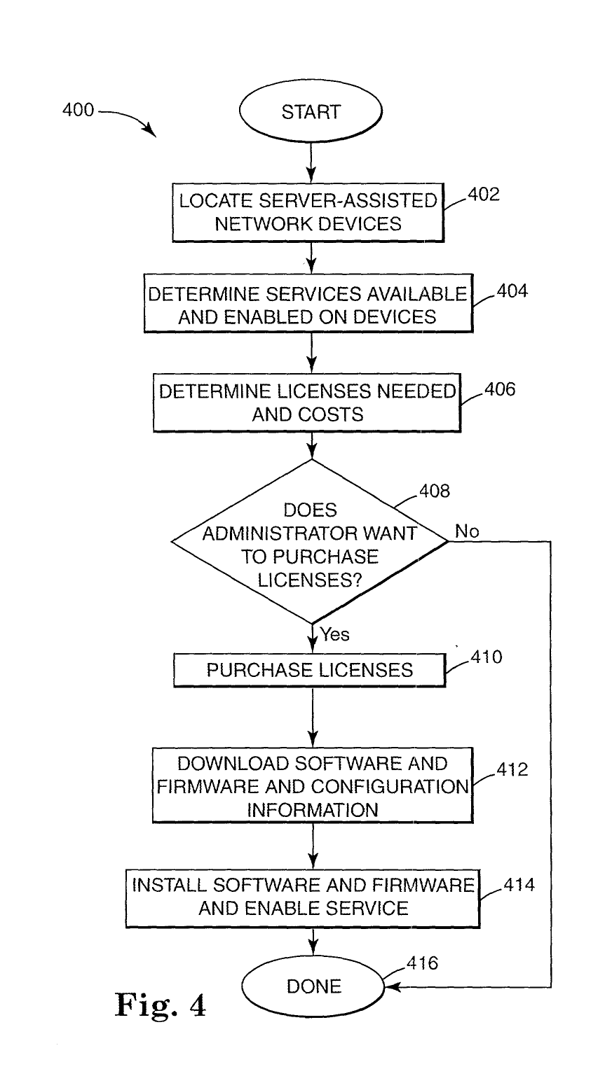

FIG. 4 illustrates a flow diagram of installation and configuration operations that are performed during the installation of software product 364B. In one embodiment, process 400 is stored on floppy disk 364A as part of software product 364B, and the operations in process 400 are performed automatically by processor 352 during execution of software product 364B.

As shown in FIG. 4, processor 352 first identifies all server-assisted network devices 101 on network 100 that are eligible to use the service provided by software product 364B. (Block 402). In one embodiment, processor 352 identifies the server-assisted network devices 101 on the network 100 by doing a network enumeration, which is a standard technique for obtaining information about a network. For each of the identified network devices 101, processor 352 determines the services currently available and enabled on the network device 101. (Block 404). In one embodiment, processor 352 determines the services currently available and enabled on the network devices 101 by examining the results of the network enumeration. Processor 352 may also obtain additional information from specific network devices 101 by querying those specific network devices 101 over network 100.

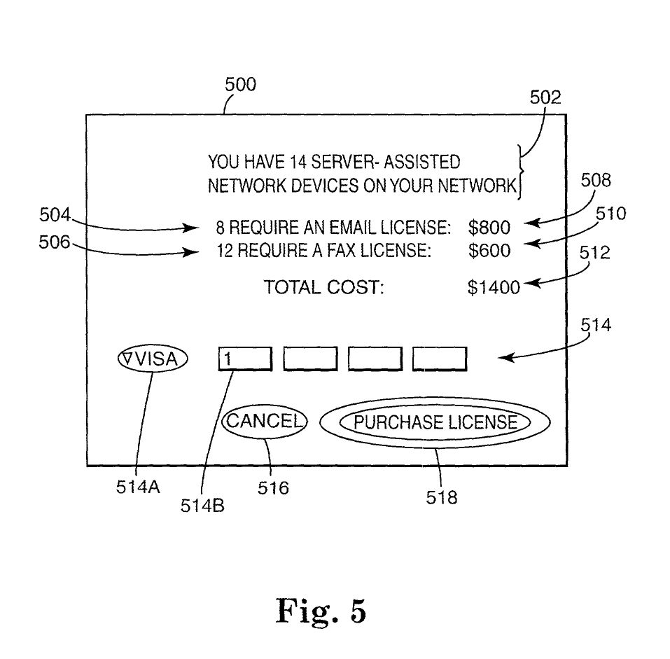

Processor 352 next determines the number of licenses needed to install software product 364B, based on the number of identified network devices 101 that will use a service provided by software product 364B, and determines the cost for the licenses. (Block 406). Processor 352 generates a license information screen that is displayed on display 358, which asks the administrator if he or she would like to purchase licenses. (Block 408). FIG. 5 shows one embodiment of a license information screen 500 that is displayed on display 358. License information screen 500 identifies the number 502 of server-assisted network devices 101 on network 100, the number 504 of server-assisted network devices 101 that are eligible to use an e-mail service provided by software product 364B, and the number 506 of server-assisted network devices that are eligible to use a fax service provided by software product 364B. Information screen 500 identifies the cost 508 for purchasing licenses for the e-mail service, the cost 510 for purchasing licenses for the fax service, and the total cost 512. License information screen 500 also includes payment input line 514, which includes payment type identifier 514A and payment source identifier 514B. A user may select any conventional form of payment with payment type identifier 514A, including a credit card, debit card, charge account, or other payment method. A user enters a payment source in payment source identifier 514B, such as a credit card number, debit card number, or charge account number. After the administrator enters payment information in payment line 514, the administrator either selects cancel button 516 to cancel the installation, or purchase license button 518 to purchase the necessary licenses and continue with the installation.

One of ordinary skill in the art will know that alternative embodiments of information screen 500 may be provided, including information screens 500 that provide additional information regarding each detected server-assisted network device 101, and information screens 500 that provide the administrator the ability to select only specific ones of the detected server-assisted network devices 101 to be provided a service. In one embodiment, the license and cost information displayed on information screen 500 is based on the specific network devices 101 selected by the administrator to receive a service.

In one embodiment, if the administrator selects purchase license button 518, the administrator is not required to configure any additional settings or provide further input. The installation and configuration are performed automatically as described below.

As shown in FIG. 4, if the administrator selects cancel button 518 and thereby chooses not to purchase the licenses (Block 408), processor 352 jumps to block 416 and the installation is not performed. If the administrator selects purchase license button 518 and thereby chooses to purchase the licenses (Block 408), processor 352 automatically purchases the necessary licenses. (Block 410). In one embodiment, processor 352 purchases the necessary licenses by first contacting license server 104 via the Internet 112. Processor 352 transmits installation information to license server 104, including the number 504 of server-assisted network devices 101 that are eligible to use an e-mail service provided by software product 362B, and the number 506 of server-assisted network devices that are eligible to use a fax service provided by software product 364B. Based on the received installation information, license server 104 automatically transmits license information and configuration information to e-mail server 110. In one embodiment, processor 352 automatically stores the received configuration and license information in memory 354 of e-mail server 110, and also transmits configuration and license information to each server-assisted network device 101 that is identified as being eligible for the email service, the fax service, or both the email and the fax service, for storage therein.

If all of the necessary software components and/or configuration information are not on floppy disk 364A, processor 352 automatically downloads any needed software and/or firmware from license server 104, or from another server, via the Internet 112. (Block 412). Alternatively, rather than downloading only a portion of the software components, all of the software components of software product 364B and configuration information may be downloaded from the Internet 112, rather than using a floppy disk 364A. If the necessary configuration and license information, or software components, cannot be obtained from license server 104, processor 352 automatically connects to one or more backup servers to obtain the necessary information.

After all of the necessary software components and configuration information for software product 364B have been obtained, whether from floppy disk 364A, Internet 112, or from another source, processor 352 installs the necessary software components on e-mail server 110 to provide the email and fax services, and configures e-mail server 110 based on the configuration information. (Block 414). The installed software components are stored in memory 354 of e-mail server 110, as represented by e-mail service software 370 and internet fax service software 372, shown in FIG. 3. Processor 352 also transmits software components from software product 364B (e.g., email client software and/or internet fax client software) to the identified server-assisted network devices 101, to enable email and internet fax services on the identified devices. (Block 414). The software components are stored in memory 154 of each network device 101, as represented by email client software 320, and internet fax client software 340 stored in memory 154 of server-assisted network device 101A (shown in FIG. 2). If necessary, processor 352 also transmits any firmware that is required to use the email and/or fax services to the identified server-assisted network devices 101. (Block 414). After installation and configuration of email service software 370 and internet fax service software 372 on e-mail server 110, and of email client software 320 and internet fax client software 340 on server-assisted network device 101A, e-mail server 110 and server-assisted network device 101A work together to provide e-mail and internet fax services to users as described above.

The present invention automates the process of installing and configuring a software product on a server that provides a service to one or more server-assisted network devices. The present invention provides numerous advantages over current techniques. The invention eliminates the need for an administrator to manually purchase, obtain and enter license information, manually establish connections to server-assisted network devices, and manually configure the system.

It will be understood by a person of ordinary skill in the art that functions performed by a server-assisted network device 101, and servers 110 and 122, may be implemented in hardware, software, firmware, or any combination thereof. The implementation may be via a microprocessor, programmable logic device, or state machine. Components of the present invention may reside in software on one or more computer-readable mediums. The term computer-readable medium as used herein is defined to include any kind of memory, volatile or non-volatile, such as floppy disks, hard disks, CD-ROMs, flash memory, read-only memory (ROM), and random access memory. It will also be understood by one of ordinary skill in the art that the techniques disclosed herein are not limited to e-mail and fax communications, but may be applied to any other network communications as well.

Although specific embodiments have been illustrated and described herein for purposes of description of the preferred embodiment, it will be appreciated by those of ordinary skill in the art that a wide variety of alternate and/or equivalent implementations may be substituted for the specific embodiments shown and described without departing from the scope of the present invention. Those with skill in the chemical, mechanical, electromechanical, electrical, and computer arts will readily appreciate that the present invention may be implemented in a very wide variety of embodiments. This application is intended to cover any adaptations or variations of the preferred embodiments discussed herein. Therefore, it is manifestly intended that this invention be limited only by the claims and the equivalents thereof.

What is claimed is:

1. A method of installing components of a software product on a first network server device coupled to a network, the components of the software product providing the first network server device the capability to provide a first service to a plurality of server-assisted network devices coupled to the network, the method comprising:
automatically detecting with the first network server device a first set of server-assisted network devices coupled to the network that are eligible to use the first service;
automatically transmitting device information based on the detected server-assisted network devices to a second network server device;
receiving license information from the second network server device based on the transmitted device information; and
automatically installing components of the software product on the first network server device.

2. The method of claim 1, and further comprising:
automatically installing components of the software product on each server-assisted network device in the first set.

3. The method of claim 1, and further comprising:
displaying an information screen identifying the number of server-assisted network devices in the first set.

4. The method of claim 1, and further comprising:
displaying cost information based on the number of server-assisted network devices in the first set, the cost information representing the cost to install components of the software product and provide the first service to the server-assisted network devices in the first set.

5. The method of claim 1, and further comprising:
receiving payment information identifying a means of payment for use of the software product.

6. The method of claim 5, and further comprising:
automatically transmitting the payment information to the second network server device.

7. The method of claim 1, and further comprising:
automatically storing at least a portion of the received license information on the first network server device.

8. The method of claim 1, and further comprising:
automatically storing at least a portion of the received license information on each server-assisted network device in the first set.

9. The method of claim 1, and further comprising:
automatically installing firmware on each server-assisted network device in the first set to support the first service.

10. The method of claim 1, wherein each server-assisted network device in the first set is one of a personal computer, printer, scanner, and a digital sender device.

11. The method of claim 1, and further comprising:
receiving device selection information from a user identifying server-assisted network devices in the first set that are to be provided the first service.

12. The method of claim 11, and further comprising:
automatically installing components of the software product on each identified server-assisted network device.

13. The method of claim 11, and further comprising:
displaying cost information based on the number of identified server-assisted network devices, the cost information representing the cost to install components of the software product and provide the first service to the identified server-assisted network devices.

14. A network server device configured to facilitate the installation of components of a software product, the components of the software product providing the network server device the capability to provide a first service to a plurality of server-assisted network devices coupled to the network, the network server device comprising:
a controller configured to automatically detect a first set of server-assisted network devices coupled to the network that are eligible to use the first service;
a transmitter for automatically transmitting device information based on the detected server-assisted network devices to a second network server device;
a receiver for receiving license information from the second network server device based on the transmitted device information; and
the controller further configured to automatically install components of the software product on the network server device.

15. The network server device of claim 14, wherein the controller is further configured to automatically install components of the software product on each server-assisted network device in the first set.

16. The network server device of claim 14, wherein the controller is further configured to automatically installs firmware on each server-assisted network device in the first set to support the first service.

17. A computer-readable medium having computer-executable instructions for performing a method of installing components of a software product on a first network server device coupled to a network, the components of the software product providing the first network server device the capability to provide a first service to a plurality of server-assisted network devices coupled to the network, comprising:
automatically detecting with the first network server device a first set of server-assisted network devices coupled to the network that are eligible to use the first service;
automatically transmitting device information based on the detected server-assisted network devices to a second network server device;
receiving license information from the second network server device based on the transmitted device information; and
automatically installing components of the software product on the first network server device.

18. The medium of claim 17, wherein the method further comprises:
automatically installing components of the software product on each server-assisted network device in the first set.

19. The medium of claim 17, wherein the method further comprises:
displaying an information screen identifying the number of server-assisted network devices in the first set.

20. The medium of claim 17, wherein the method further comprises:
displaying cost information based on the number of server-assisted network devices in the first set, the cost information representing the cost to install components of the software product and provide the first service to the server-assisted network devices in the first set.

21. The medium of claim 17, wherein the method further comprises:
receiving payment information identifying a means of payment for use of the software product.

22. The medium of claim 21, wherein the method further comprises:
automatically transmitting the payment information to the second network server device.

23. The medium of claim 17, wherein the method further comprises:
automatically storing at least a portion of the received license information on the first network server device.

24. The medium of claim 17, wherein the method further comprises:
automatically storing at least a portion of the received license information on each server-assisted network device in the first set.

25. The medium of claim 17, wherein the method further comprises:
automatically installing firmware on each server-assisted network device in the first set to support the first service.

26. The medium of claim 17, wherein each server-assisted network device in the first set is one of a personal computer, printer, scanner, and a digital sender device.

27. The medium of claim 17, wherein the method further comprises:
receiving device selection information from a user identifying server-assisted network devices in the first set that are to be provided the first service.

28. The medium of claim 17, wherein the method further comprises:
automatically installing components of the software product on each identified server-assisted network device.

29. The medium of claim 17, wherein the method further comprises:
displaying cost information based on the number of identified server-assisted network devices, the cost information representing the cost to install components of the software product and provide the first service to the identified server-assisted network devices.
